(19) United States
(12) Patent Application Publication
(10) Pub. No.: US 2010/0235742 A1
(43) Pub. Date: Sep. 16, 2010

(54) DEVICE FOR DISPLAYING A PLURALITY OF MULTIMEDIA DOCUMENTS

(75) Inventors: Shuo Hsiu Hsu, Rennes (FR); Sylvie Jumpertz, Rennes (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/681,805

(22) PCT Filed: Oct. 7, 2008
(86) PCT No.: PCT/FR2008/051812

§ 371 Date: Apr. 6, 2010

(30) Foreign Application Priority Data
Oct. 12, 2007 (FR) 0758263

(51) Int. Cl. G06F 3/01

(52) U.S. Cl. 715/716

(57) ABSTRACT

The invention relates to a device for displaying multimedia documents. According to the invention, such a device includes: organization means adapted to organize said multimedia documents into at least first and second sets of multimedia documents disposed in a first direction; and browsing means adapted to respond to at least one first predetermined movement of a user to browse between said first and second sets of multimedia documents in said first direction.

The present invention relates to the field of the management of multimedia documents.

To be more precise, the invention relates to a method of displaying a set of such documents that facilitates accessing, organizing, and browsing the documents.

The invention is suitable for use, in particular, in a terminal, for example a communications terminal of the mobile telephone type, but equally in all other types of terminal, or in image capture devices of the digital still camera or camcorder type, which have a memory for storing shots, images, videos, etc. and/or can be connected to a communications network to access services delivering multimedia contents.

Today communications terminals are capable of shooting still pictures and/or videos just like a digital still camera or camcorder and of accessing multimedia content servers.

The provision in mobile communications terminals of this capacity to capture, receive, or create audiovisual documents, or more generally multimedia documents (photos, images, videos, etc.), implies new usage problems linked essentially to the difficulty for communications terminal users of choosing between virtually infinite amounts of multimedia data made available by multimedia content providers and/or mobile telephone operators for consulting from their mobile communications terminals.

Until now, audiovisual contents has been accessed or more generally browsed, essentially by means of fixed terminals, of the desktop computer type, which usually include an Internet browser and user interface means of the keyboard and/or mouse type.

The most familiar examples are available on a television receiver via a remote control for browsing a program guide or video on demand (VOD) catalog, such catalogs often being presented in the form of lists of videos, or more generally of multimedia contents accessible to users.

Other prior art solutions are available on personal computer (PC) type terminals, for example via text search engines, such as Google (Registered Trade Mark) and more recently YouTube (Registered Trade Mark), where YouTube provides users with functions for searching, accessing, and viewing video documents categorized according to an infinite number of categories of documents, most often available by means of a keyword search.

Users of these two search engines find themselves in the situation of consultation via a fixed station with a keyboard and a mouse.

A drawback of those access modes is that it is difficult to transpose them to mobile communications terminals, the ergonomics of which do not lend themselves to implementing search engines or even browser functions for browsing a large number of multimedia documents available via mobile terminals, which usually have no such functions for accessing and/or browsing a large number of multimedia documents.

The present invention offers a solution that does not present the above-mentioned drawbacks.

The invention aims to remove the above-mentioned drawbacks by proposing a method and a device for managing multimedia documents that provide for accessing and browsing audiovisual, or more generally multimedia, content access services from a simplified terminal, for example a mobile telephone.

In particular, the present invention makes it possible both to facilitate accessing and managing a large set of multimedia documents from a terminal having limited resources, and to provide simple and ergonomic manipulation of the documents from such a terminal, for example a mobile telephone.

To this end, the invention provides a method of displaying multimedia documents, the method advantageously comprising:
a step of organizing said multimedia documents into at least first and second sets of multimedia documents disposed in a first direction; and
a step of responding to at least one first predetermined movement of a user to move between said first and second sets of multimedia documents in said first direction.

Thus in a first step this method organizes a large set of multimedia documents either produced directly by a terminal having hardware and/or software resources for doing this or coming from a multimedia content server accessed from the terminal, for example a YouTube (Registered Trade Mark) type server for searching and/or consulting video documents.

Such a management structure for organizing a large number of multimedia documents comprising sets of multimedia documents disposed relative to one another in a predetermined direction, each set possibly corresponding, by way of non-limiting illustrative example, to a particular category of documents, advantageously supports a step of responding to a first predetermined movement of a user to enable the user to browse the multimedia documents constituting the sets of documents.

This greatly facilitates browsing a set of multimedia documents, users being able to browse the sets of documents by means of simple gestural interaction, which is also more efficient and ergonomic, especially if a large number of multimedia documents are to be manipulated simultaneously.

Moreover, browsing a corpus of multimedia documents using interaction means based on responding to a predetermined gesture and/or movement of the user proves to be totally compatible with and suitable for a mobile terminal able to connect to multimedia content servers to access multimedia document corpuses of large size (from a few dozen documents to a few thousand documents) and browse them quickly and efficiently.

The method of the invention thus has the advantage of making provision for accessing, and most importantly browsing, multimedia content access services from a simplified terminal, for example a mobile terminal.

Such a method may also manage a plurality of still photograph or video images acquired directly by a digital still camera or camcorder, categorizing the multimedia documents created according to the above-mentioned management structure, to facilitate subsequent accessing and browsing of the documents by users.

In a preferred implementation of the invention, said method further comprises:
a step of organizing said multimedia documents of said at least first and second sets of multimedia documents into the form of a two-dimensional matrix; and
a step of responding to at least one second predetermined movement of said user to move from one document to another in said two-dimensional matrix.

Such an organization step structures the display in the viewing area of all of the multimedia documents corresponding to a particular category in a format that is easy to browse taking the form of a two-dimensional matrix. In that matrix, multimedia documents of the same category are displayed in the form of thumbnails for users to select from.

Responding to a second predetermined movement of a user enables the user to move from one thumbnail to another in said two-dimensional matrix, which helps to make this easier and more ergonomic for users.

The display method of the invention preferably further includes a step of selecting at least one document from said plurality of multimedia documents.

Such a selection step may advantageously be implemented by capturing an action of the user on a touch-sensitive screen in a viewing area in which a category or set of said multimedia documents is displayed in accordance with said two-dimensional matrix structure.

In a preferred implementation of the invention, said method advantageously includes a step of responding to at least one third predetermined movement of said user to zoom in or out of said at least one selected multimedia document in the viewing area.

Thus combined use of the above three predetermined movements enables users to browse a large set of multimedia documents (simultaneously containing up to several thousand documents) previously organized into various categories and to select them for consultation.

In the context of such a method, the first, second, and third movements of a user may be captured by a hardware device forming a haptic interface of a mobile terminal, by way of non-limiting example an MP4 terminal, a personal digital assistant (PDA), etc. In a variant of the invention the movement may be captured by capture means that do not require any haptic contact with the user.

The invention also relates to a device for displaying multimedia documents. Such a device advantageously includes:
organization means adapted to organize said multimedia documents into at least first and second sets of multimedia documents disposed in a first direction;
browsing means adapted to respond to at least one first predetermined movement of a user to browse between said first and second sets of multimedia documents in said first direction.

Preferably:
the organization means are adapted to organize said multimedia documents of said at least first and second sets of multimedia documents into a two-dimensional matrix; and
the browsing means are adapted to respond to at least one second predetermined movement of said user to move from one document to another in said two-dimensional matrix.

In one advantageous embodiment of the invention, said display device further comprises means for selecting at least one document from said plurality of multimedia documents. Such selection means may take the form, for example, of a touch-sensitive screen adapted to respond to contact with the user in a predetermined interface area.

The browsing means are advantageously adapted to respond to at least one third predetermined movement of said user to zoom in or out in said selected at least one multimedia document in a viewing area.

Said browser means preferably include controls disposed around said viewing area.

In one particular embodiment of the invention, said browsing means include circular touch-sensitive means around said viewing area and a cylinder adapted to slide between a start position and an end position to browse said at least first and second sets of multimedia documents.

In one embodiment of the invention, said display device further includes means for displaying information representative of a set of documents displayed in said viewing area, which continuously offers the user position information inside the categories of multimedia documents that they are browsing.

The invention also provides a terminal including means for storing a plurality of multimedia documents, characterized in that it includes a display device of the invention.

The invention further provides a communications terminal including means for connecting it to a communications network to access multimedia content accessible on multimedia content servers, said terminal including a display device of the invention for browsing said multimedia contents.

The invention further provides a picture-shooting device including at least one viewfinder area and magnification adjustment means, said device offering a first operating mode for shooting and a second operating mode for managing a plurality of shots stored in a memory. According to the invention, said device includes a display device of the invention.

Such a device offers users greater ease of managing and organizing multiple shots that they have taken and highly ergonomic browsing of shots stored in memories of their devices.

In one ingenious embodiment of the invention, in the second operating mode said viewfinder area is adapted to form said viewing area and said browser means are adapted to be controlled via said magnification adjustment means, for example the lens or zoom lens equipping such a device.

The technical advantages and features of the present invention emerge more clearly from the following description, given by way of non-limiting illustration and with reference to the appended drawings, in which:

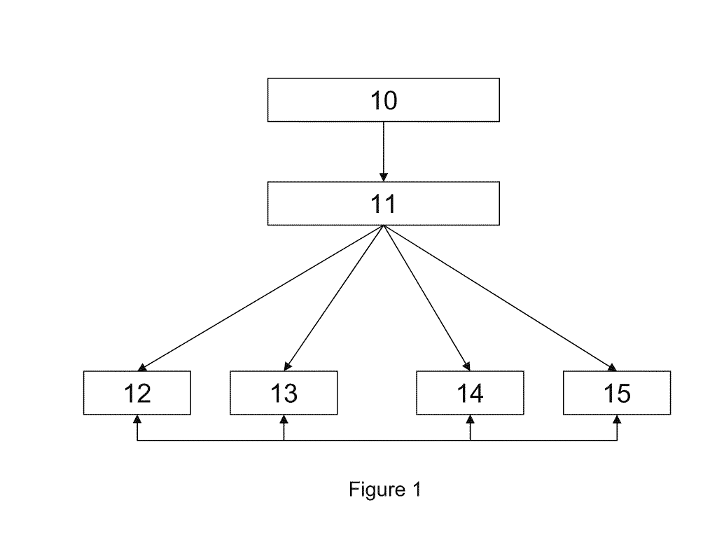

FIG. 1 is a flowchart showing the main steps of the method of the invention of displaying multimedia documents;

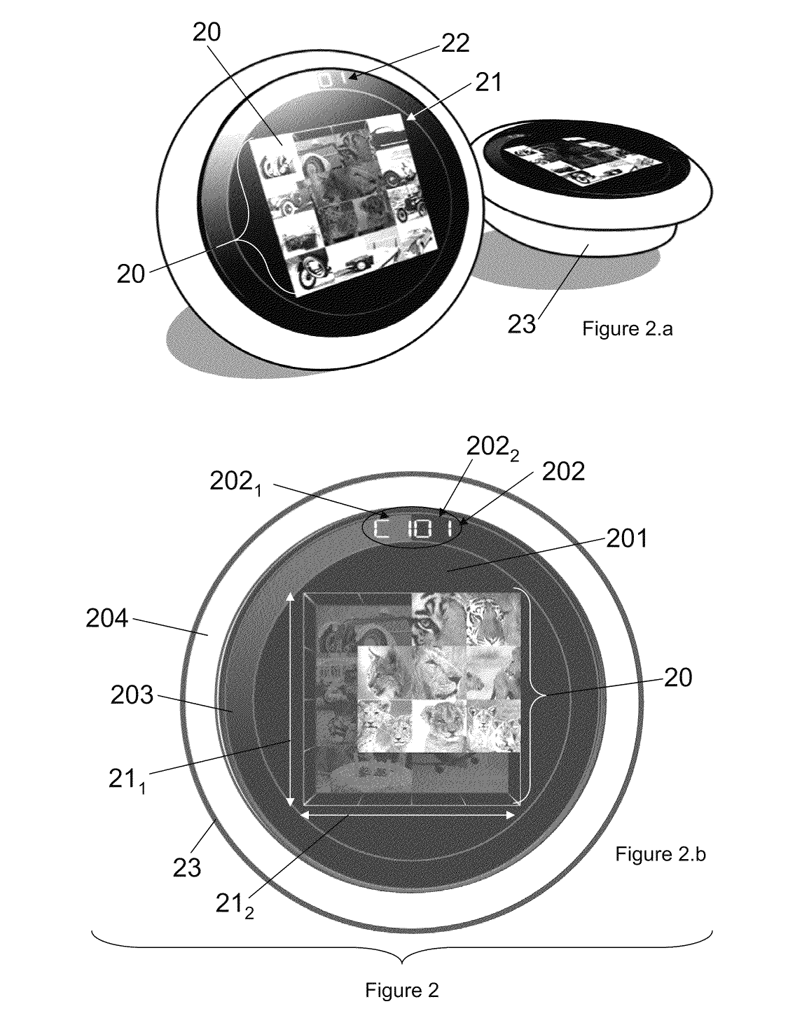

FIGS. 2.a and 2.b show an example of a multimedia document management device of the invention, respectively in profile and from above;

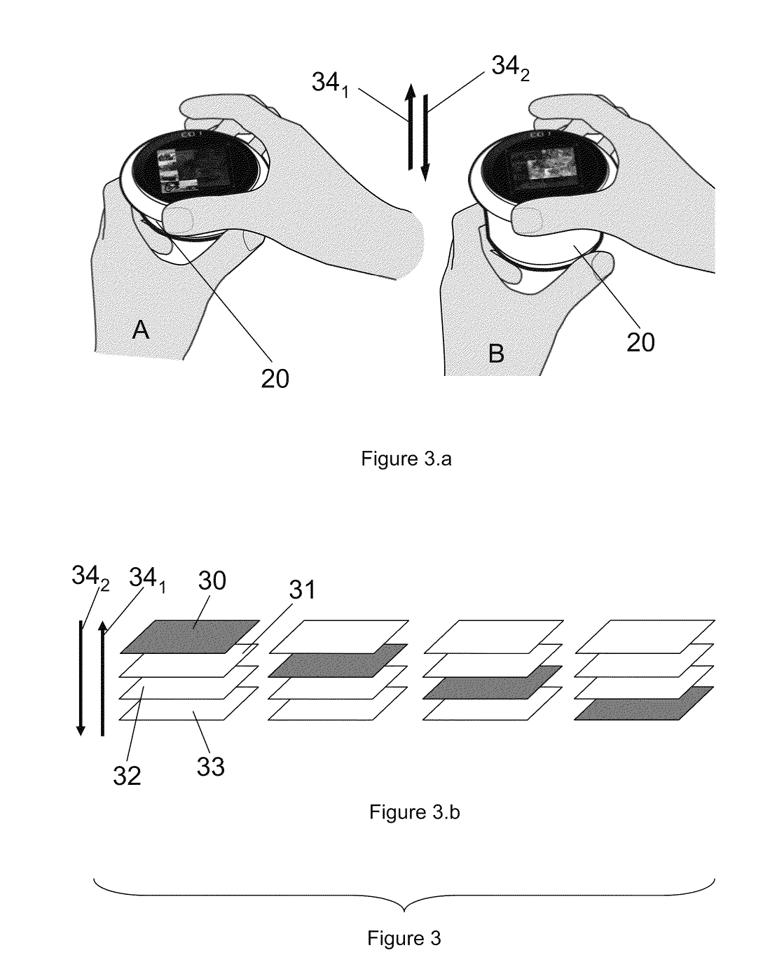

FIGS. 3.a and 3.b illustrate the principle of a multimedia document management device of the invention responding to a first predetermined movement of a user;

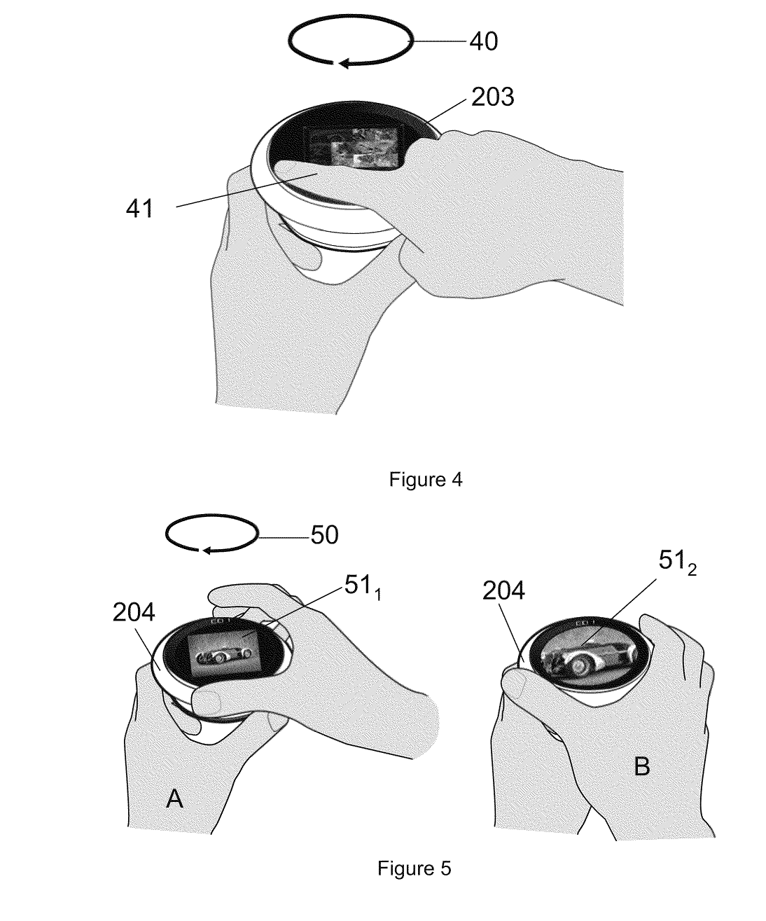

FIG. 4 shows the principle of a management device of the invention responding to a second predetermined movement of a user; and

FIG. 5 shows the principle of a management device of the invention responding to a third predetermined movement of a user.

Thus the present invention proposes a new technique for managing and browsing a large set of multimedia documents from a terminal that is simplified in terms of its interface but that provides for interaction with such a set, for example a mobile telephone adapted to be connected to content servers via an Internet connection.

As shown in FIG. 1, the invention consists in a method of managing a plurality of multimedia documents. Such a method advantageously includes the following steps:
a first step 10 of organizing said multimedia documents into at least first and second sets of multimedia documents disposed in a first direction; and
a step 12 of responding to at least one first haptic gestural movement of a user to move between said first and second sets of multimedia documents in said first direction.

Such a method further includes a second step 11 of organizing said multimedia documents of said at least first and second sets of multimedia documents into a two-dimensional matrix.

It is of course possible to envisage any other way of organizing the documents of a subset of multimedia documents, for example into a mosaic of documents, and each subset may correspond to a grouping according to a predetermined category.

Such a method also includes a step 13 of responding to at least one second predetermined movement of said user to move from one document to another in said two-dimensional matrix.

It further includes a step 14 of selecting at least one document from said plurality of multimedia documents and a step 15 of responding to at least one third haptic gestural movement of said user to zoom in or out in said selected at least one multimedia document in a viewing area.

Thus the method of the invention relies on responding to at least three gestures of the user to offer new and ergonomic functions for browsing a corpus or set of multimedia documents, in particular audiovisual documents, obtained from a content server or acquired directly by the terminal (photographs or videos).

As shown in FIGS. 2.a and 2.b, to implement such a method, a device for managing a plurality of multimedia documents is proposed that is adapted to respond to interaction with the user based on the three haptic gestures of the user.

As shown in FIG. 2.a, such a device includes at least one viewing area 20 to view the browsing of a subset of a larger set of multimedia documents organized for example in the form of a matrix 21 of two dimensions 21₁ and 21₂.

It is of course possible to envisage a different embodiment of such a device having no viewing area of its own, but merely means for co-operating with a screen of another device, for example a screen of a mobile telephone or a viewfinder or viewing screen of a digital camera including said device. Such a screen would then be used to display a user's multimedia documents.

As shown in FIG. 2.a, there is a connection between the subset 21 of multimedia documents and the display area 22 in which the subset of multimedia documents displayed in said viewing area 20 is identified. As shown in FIG. 3.b, each subset 21 of multimedia documents may advantageously correspond either to an arbitrary selection of documents from an initial set of multimedia documents (obtained for example in response to a search request submitted to a multimedia content server such as YouTube (Registered Trade Mark) or FlickR (Registered Trade Mark)) or to the result of filtering said initial set, and under such circumstances each identified subset may correspond to a particular category organized into a layer (30, 31, 32, 33—FIG. 3.b) in a structure with (at least) three dimensions for managing said documents. In such a structure, each category is identified in a category identification display area 22 when the associated documents are displayed in the display area 20, for example in the form of a layer or category number.

In one embodiment of the FIG. 2.b management device, a sliding cylinder type mechanism 23 captures the first haptic gesture of a user, with sliding of the cylinder 23 making it possible to browse from one to another of the layers of multimedia documents corresponding to the subsets of multimedia documents organized by the management method of the invention.

The cylinder 23 may slide between a starting position and an end position corresponding to maximum extension of the sliding cylinder. The starting position displays in the viewing area a subset of documents corresponding to the first category and the end position displays in the viewing area a subset of multimedia documents corresponding to the last category, the number of intermediate sliding positions of the cylinder being determined dynamically as a function of the number of document categories that have been identified either directly in the memory of a mobile telephone type communications terminal or in response to a request sent from said terminal to a heterogeneous multimedia content access service, for example YouTube (Registered Trade Mark) or FlickR (Registered Trade Mark).

It is of course possible to envisage other embodiments of the device of the invention in which the sliding cylinder is replaced by any other type of haptic means for moving between the subsets (30, 31, 32, 33) of multimedia documents in a predetermined direction (34₁, 34₂), for example a cylinder or other means adapted to rotate endlessly for moving from one category of multimedia documents to another.

As shown in FIG. 2.b, such a device of the invention includes:
A round touch-sensitive screen 201 that firstly expands the display capacities of said device and secondly makes using it more ergonomic for the user.
At least one area 202 for displaying information representative of a set of documents displayed in the display area. In the FIG. 2.b example, the area 202 indicates that the subset displayed in the viewing area 20 corresponds to the first layer 202₁ of the first category 202₂ of multimedia documents. In this viewing area 20 for displaying multimedia documents, the documents are displayed in a perspective view, which further improves ergonomics for users and improves perception by users.
Browsing means 203 adapted to respond to a haptic gesture of a user to move from one document to another in said matrix 21 with two dimensions (21₁, 21₂). These means advantageously take the form of a circular touch-sensitive ring around the display screen 201. As shown in FIG. 4, the user turning 40 the bar or circular ring with a finger 41 has the effect of moving a focus area from one document to an adjacent document. Depending on the direction of rotation of the user's finger on the circular ring, the user advances or moves back within the corpus of multimedia documents displayed in the viewing area 20. The user also uses the browsing means 203 to browse through browsing history. Thus a circular ring associated with a touch-sensitive screen 201 enables the user firstly to browse easily and naturally through a corpus composed of a large number of multimedia documents and secondly to select a multimedia document from that corpus easily. This helps to improve the ergonomics and the ease of browsing a large number of multimedia documents, even using a mobile telephone type terminal with limited browsing capabilities, provided the terminal is equipped with a multimedia document management device of the invention.
Means 23 adapted to respond to at least one other haptic gesture of a user to move between the various layers representing the various subsets of multimedia documents (layers 30, 31, 32, 33 in the FIG. 3.b example). Such means 23 advantageously take the form of a cylinder 23 that the user can pull/push to browse the various layers (30, 31, 32, 33) of subsets of multimedia documents in the direction 34₁ or 34₂. The travel of the cylinder 23 can be calibrated automatically between a start position (view A in FIG. 3.a) and an end position (view B in FIG. 3.a) starting from a predetermined number of multimedia document presentation layers corresponding to the number of subsets of multimedia documents.
Browsing means 204 for responding at least to a third haptic gesture of said user to zoom in or out in said viewing area 20 (see FIG. 5) of at least one multimedia document (51₁, 51₂) selected using the selection function offered by the touch-sensitive screen 201 of the device of the invention. Such browsing means 204 advantageously take the form of a touch-sensitive or mobile circular ring located at the periphery of the multimedia document management device of the invention. Thus if a user has preselected a multimedia document, it suffices to turn 50 the circular ring 204 to zoom in (view B in FIG. 5) or out (view A in FIG. 5) in the selected document (for example an image, photo or video), according to the rotation direction, as shown in FIG. 5.

Thus the invention defines a device and method of managing and browsing a large number of multimedia documents in a manner that is very simple in terms of its ergonomics. Thus the invention proposes a new interface that, in contrast to prior art solutions, may easily be implemented in a mobile telephone type terminal to improve its ergonomics and to enable the user of such a terminal to access and more importantly to browse services giving access to multimedia, for example audiovisual, content in a manner that is very simple and highly ergonomic.

Thus the invention facilitates access from a mobile communications terminal to such services, by way of non-limiting example YouTube (Registered Trade Mark), PiKéo (Registered Trade Mark), or FlickR (Registered Trade Mark) services, now accessible when mobile by means of the management method and device of the invention.

1. A device for displaying multimedia documents, comprising:
organization means adapted to organize said multimedia documents into at least first and second sets of multimedia documents disposed in a first direction; and
browsing means adapted to respond to at least one first predetermined movement of a user to move between said first and second sets of multimedia documents in said first direction.

2. The device according to claim 1, wherein:
the organization means are adapted to organize said multimedia documents of said at least first and second sets of multimedia documents into a two-dimensional matrix; and
the browsing means are adapted to respond to at least one second predetermined movement of said user to move from one document to another in said two-dimensional matrix.

3. The device according to claim 1, further comprising means for selecting at least one document from said plurality of multimedia documents.

4. The device according to claim 3, wherein the browsing means are adapted to respond to at least one third predetermined movement of said user to zoom in or out in said selected at least one multimedia document in a viewing area.

5. The display device according to claim 4, wherein said browser means comprise controls disposed around said viewing area.

6. The display device according to claim 1, wherein said browsing means include a cylinder adapted to slide between a start position and an end position to browse said at least first and second sets of multimedia documents.

7. A communications terminal comprising means for storing a plurality of multimedia documents, said communications terminal further comprising a display device according to claim 1.

8. The terminal according to claim 7, comprising means for:
connecting it to a communications network to access multimedia content accessible on multimedia content servers,
a display device for browsing said multimedia contents, comprising:
organization means adapted to organize said multimedia documents into at least first and second sets of multimedia documents disposed in a first direction; and
browsing means adapted to respond to at least one first predetermined movement of a user to move between said first and second sets of multimedia documents in said first direction.

9. A picture-shooting device comprising at least one viewfinder area and magnification adjustment means, said device offering a first operating mode for shooting and a second operating mode for managing a plurality of shots stored in a memory, said device further comprising a display device according to claim 1.

10. The picture-shooting device according to claim 9, wherein in the second operating mode said viewfinder area is adapted to form said viewing area and said browser means are adapted to be controlled via said magnification adjustment means.
